(19) United States
(12) Patent Application Publication
(10) Pub. No.: US 2020/0156722 A1
(43) Pub. Date: May 21, 2020

(54) METHOD OF MANUFACTURING AN AUTOMOTIVE VEHICLE USING AUTONOMOUS CONVEYANCE OF A VEHICLE CHASSIS

(71) Applicant: VOLKSWAGEN GROUP OF AMERICA, INC., Herndon, VA (US)

(72) Inventors: Adam Keith WATKINS, Hixson, TN (US); Douglas Herbert BARTOW, Signal Mountain, TN (US); Simon Heinrich STARK, Chattanooga, TN (US); Harold WALTERS, Hixson, TN (US); Antonio PINTO, Chattanooga, TN (US)

(73) Assignee: VOLKSWAGEN GROUP OF AMERICA, INC.

(21) Appl. No.: 16/194,527

(22) Filed: Nov. 19, 2018

(51) Int. Cl. B62D 65/18; B62D 65/00; B62D 65/02; B62D 15/02

(52) U.S. Cl. CPC B62D 65/18; B62D 15/0265; B62D 65/022; B62D 65/005

(57) ABSTRACT

A system and method for manufacturing a motor vehicle using autonomous conveyance of a vehicle chassis and a control system to execute functions including steering, acceleration/deceleration, environment monitoring and obstacle avoidance.

### FIELD

The present disclosure relates to systems, components and methodologies for automotive vehicle manufacturing, and more particularly to the sequence of fabrication steps and incorporation of autonomous vehicle functions in the manufacturing and delivery process and configuration of assembly lines and facilities.

### BACKGROUND OF THE INVENTION

Conventional automotive vehicle assembly requires a vehicle or vehicle body to be carried through the assembly line by a sequence of conveyance devices through multiple part assembly stations to produce a completed vehicle. The finished vehicle is pulled off the conveyance devices only at the very end of the process. Traditional assembly operations require lifts, tugger vehicles, conveyors, elevator equipment, autonomous guided vehicles to deliver parts to sequential installation stations, and personnel to load and unload supplier parts. Finished products are then driven to a desired destination either on-site or elsewhere.

### SUMMARY OF THE INVENTION

Systems, components, and methodologies are disclosed for manufacturing an automobile, or other automotive vehicle, using autonomous conveyance of a vehicle chassis. Disclosed embodiments reduce or eliminate expensive conveyance equipment and may streamline the manufacturing process.

In traditional vehicle manufacturing, the drive unit is merged with the body after the front end is assembled. By employing a non-conventional sequence of vehicle manufacturing steps, a portion of the assembly process can be performed on a self-powered, self-guided vehicle.

According to illustrative embodiments, first a chassis, fluid-filled powertrain and wheels are assembled. This may be accomplished using conventional manufacturing processes, including those that employ conveyors. The vehicle is then self-powered and self-guided through all or most of the remaining fabrication and delivery steps. Thus, the need for expensive conveyor, lift and elevator equipment may be reduced or eliminated. Disclosed embodiments may also eliminate several steps from the supply chain process by allowing self-powered and self-guided vehicles to move to supplier warehouses located in the vicinity of the original equipment manufacturing factory. Illustrative embodiments may also allow flawed vehicle builds to be taken out of the line, thereby permitting other cars in the line to continue along the manufacturing process, thus decreasing or avoiding production line stoppages. A control system is disclosed with the ability to access the steering system; sense surroundings and get to the right place at the right time; communicate with a central “brain” that knows where all the vehicles are at all times; and to communicate with various stations, for example, assembly, installation, testing and alignment stations, to let them know the vehicle is coming, what kind of vehicle it is, what parts it needs, and any other information helpful or necessary to the station action.

### DESCRIPTION OF THE DRAWINGS

The detailed description particularly refers to the accompanying figures, which depict illustrative embodiments, and in which:

FIG. 1 is a schematic of a control system 100 for a vehicle moving through an assembly line.

FIG. 2 is a block diagram providing an overview of a self-guided, self-propelled vehicle control system 100.

FIG. 3 is a block diagram of a vehicle control system 100 for use during vehicle manufacturing.

FIG. 4 is a schematic of an illustrative production layout.

FIG. 5 is a schematic of a production layout according to a further illustrative embodiment.

FIG. 6 is a schematic of an illustrative production layout 600 according to a further embodiment in which wheel installation is shifted further toward the beginning of the manufacturing process.

FIG. 7 is a flowchart depicting an object avoidance scheme according to an illustrative embodiment.

FIG. 8 is a flowchart of an illustrative vehicle's path along an assembly line through multiple stations.

FIG. 9 is a flowchart of a vehicle steering autonomously through a manufacturing plant.

### DETAILED DESCRIPTION OF ILLUSTRATIVE EMBODIMENTS

All embodiments and components described and depicted herein are illustrative examples only.

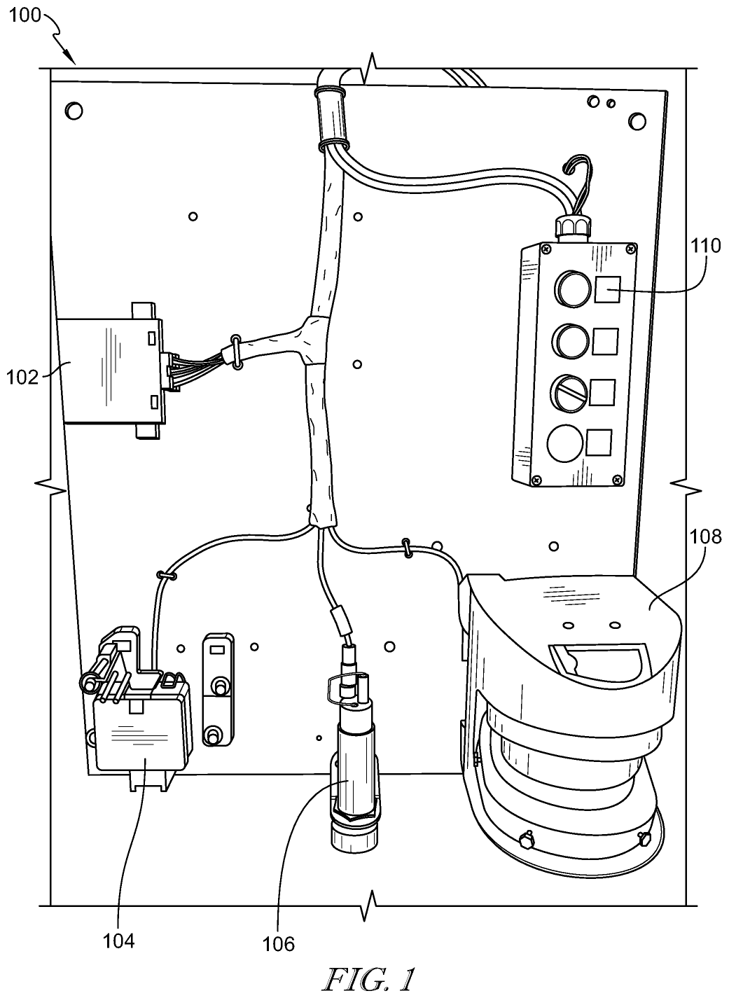

FIG. 1 is a schematic of a control system 100 for a vehicle moving through an assembly line. Control system 100 engages with the vehicle to allow it to be self-powering and self-guiding, provided that required components have been incorporated into the vehicle. These components include, for example, all or portions of the chassis, power/accelerator system, steering system, braking system, computer, and wheels. Control system 100 is configured to operate in a manner compatible with the vehicle manufacturing process. This includes physical components and positioning of control system 100 with respect to the vehicle, and its electronic and software application compatibility with those of the manufacturing process.

The term “vehicle” as used herein means, if not specifically stated, either a fully or partially fabricated vehicle, depending on the context in which the term is used. The term “assembly line” or “line” includes any series of manufacturing steps, and does not necessarily mean an actual line or uninterrupted series of stations as in the traditional manufacturing sense.

In an illustrative embodiment, control system 100 includes gateway 102, radar sensor 104, visual management guide sensor 106, secondary pedestrian safety scanner 108 and user interface 110. Additional or other combinations of sensors, interfaces and gateways may be included in control system 100. Illustrative sensors include: radar sensors, mono and stereo cameras, near, medium and high range cameras, LIDAR systems and ultra sound sensors. Some of these systems may be implemented in a redundant or overlapping manner. For simplicity, the term “camera” may include any type of image capture device, which may capture still or video images that would be compatible with the vehicle and manufacturing process.

Any autonomous or driver assist technology that can facilitate a vehicle progressing through the assembly line may be incorporated into control system 100, including, for example, technology to guide, propel and stop the vehicle along the assembly line. More specifically, control system 100 may autonomously execute one or more of the following functions: steering, acceleration and deceleration; monitoring of the environment; and dynamic driving task fallback strategies. These capabilities may be incorporated into subsystems on control system 100, generally known as park assist, blind spot monitoring, lane-keeping assist or lane centering, collision avoidance, adaptive cruise control, cross-traffic monitoring, brake assist, distance control and emergency braking, for example, or other autonomous vehicle functionality that can facilitate a driverless vehicle progressing through an assembly line. Subsystems may provide assistance or avoidance functions and/or generate warning signals such as audio or visual alerts.

By way of example, a combination of cameras radar or other sensors is used to analyze a vehicle's speed and its distance to other vehicles or objects. The positions and movement of objects can also be obtained by this combination of cameras sensors, which may be provided as input to vehicle control algorithms. Other illustrative input parameters are LIDAR or ultrasound-generated signals that represent objects or humans in the vicinity of the vehicle. Vehicles may be equipped to recognize and act on signage information. Signage may be fixed or provided as a changeable display that can be altered according to changes in desired assembly line manufacturing steps.

Examples of technology/components/subsystems to be include:

Audi Traffic Jam Assist

Adaptive Cruise Control

PLA

Electronic Power Steering

Anti-Crash

Loading Cells

Remote guidance

Magnetic Guidance

External Control Module

Interface with the vehicle

Programmable route

Path Guidance Device (Vision)

Object Detection System

GPS Monitoring

Human Machine Interface

Visual Guidance System

Personnel Detection System

Emergency Stop

Control system 100 may use a centralized architecture having a central control unit that processes parameters input from a plurality of sensors. Alternatively, more than one control system may be used in a distributed arrangement, wherein each control system governs different functions of an autonomous system. Control system 100 may decode and analyze images, and other input parameters obtained from various sensors.

Gateway 102 serves as an interface between inputs from the sensors and the vehicle. Gateway 102 transforms data from radar sensor 104 and visual management guide sensor 106 into commands to operate the vehicle, such as for example, speed up, slow down, go left, go right, stop, reverse, forward, etc. The data is transformed based on parameters ascertained by sensors 104, 106 or other sensors employed in the system. The data may undergo an initial processing before serving as the basis of a command. For example, parameters may be analyzed to determine if they are within particular ranges or meet designated thresholds.

Visual management guide sensor 106 follows a pre-determined path (magnetic strip or visual guidance) and feeds data back to gateway 102 to ensure that the vehicle is moving on the correct path within the confines of the allowed space along an X-axis (left to right path). For example, the assembly line can be mapped out and the vehicle guided along the mapped path. Accordingly, if the vehicle encounters obstacles, it may arrest movement to the vehicle or guide the vehicle along its mapped path after the vehicle navigates around the obstacle.

Radar sensor 104 ensures correct speed and distance from a Y-axis perspective, wherein the Y-axis is defined as the line of forward or backward movement of the vehicle. For example, radar sensor 104 may sense the distance between a vehicle and a station. The distance information is fed back through gateway 102 to control system 100, which provides a signal to the vehicle to cause it to speed up, slow down, stop, or start as needed, and position itself appropriately with respect to the station. It is noted that the control system can also be programmed so the X-axis and Y-axis are referenced to the plant coordinates.

A pedestrian safety scanner 108, such as a laser scanner, detects interferences in the travel path of the vehicle, and signals the vehicle to either stop or go based on clearance. Clearances are fed back through gateway 102 to control system 100, which provides a signal to the vehicle to cause it to speed up, slow down, stop, or start as needed. An illustrative scanner 108 is a spinning LIDAR unit that uses laser beams that reflect back to the LIDAR unit to create a 360 degree image of the vehicle's surrounding.

A user interface 110 allows an operator to input commands to start and stop the assembly line system. User interface 110 may be either graphical, for example a display screen, or non-graphical, for example buttons or switches. Gateway 102, radar sensor 104, visual management guide sensor 106 and secondary pedestrian safety scanner 108 may be incorporated into a single control system 100 that can be functionally attached (mechanically and electrically) to a vehicle that has been assembled to the point of being able to be self-powered and self-guided. Once activated, control system 100 will allow the vehicle to progress along the assembly line without, or with little, human intervention or use of conveyors or lifts. User interface 110 allows or disallows gateway 102 to communicate with the vehicle. It also serves as a manual override for the system so the system can be shut own, such as in an emergency situation.

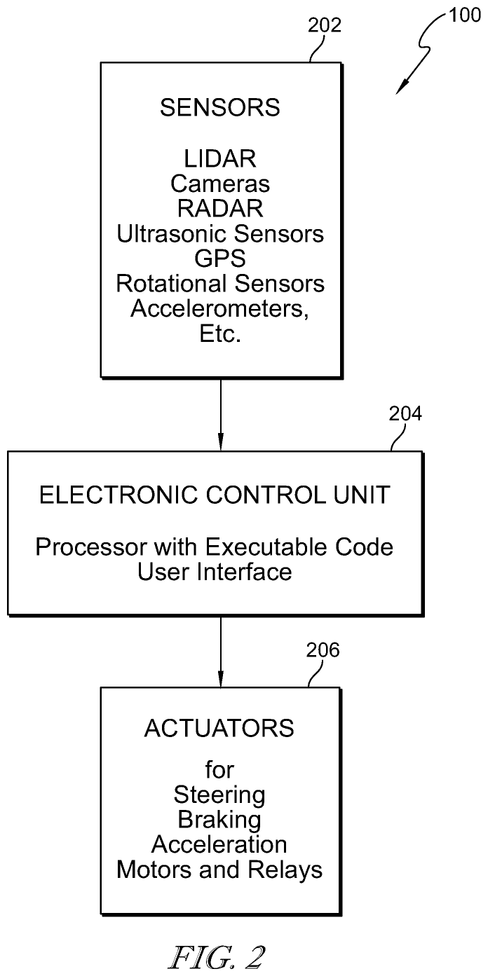

FIG. 2 is a block diagram providing an overview of a self-guided, self-propelled vehicle control system 100. Vehicle control system 100 is the system employed to provide autonomous vehicle functionality. Vehicle control system 100 may include three main components, sensors 202, electronic control unit 204 and actuators 206. The three main components 202, 204, 206 correlate to three types of actions: sensing, understanding and acting, respectively.

Illustrative sensors 202 include LIDAR, camera or other optical image capture device, radar, geo-positioning system (GPS) and wheel speed sensor.

Electronic control unit 204 receives input from sensors 202, which is processed to produce signals representative of decision making results. Electronic control unit 204 may include machine readable code, which when executed, guides and controls a vehicle through an assembly line where it undergoes various manufacturing steps. The machine readable code includes algorithms, such as those to implement various autonomous vehicle functionality. Electronic control unit 204 may also include a user interface, which, by way of example, may be a display screen or non-graphical user interface.

Actuators 206 receive signals from electronic control unit 204, which direct the actuators to turn on or off, or implement actions as dictated by the received signals. Actuators 206 may, for example, control acceleration, braking and steering.

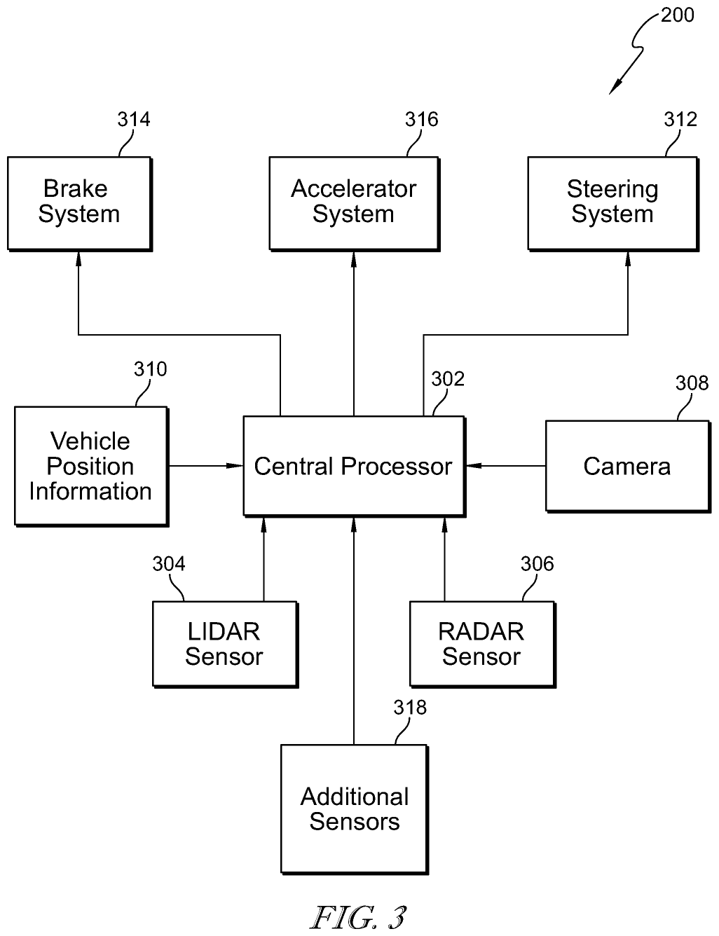

FIG. 3 is a block diagram of a vehicle control system 100 for use during vehicle manufacturing. A central processor 302 may be a single processor or a plurality of processors acting individually or in unison. Central processor 302 may be, for example, a microprocessor, and application specific processor, or other programmable or programmed electronic device. Signals generated by sensors, such as LIDAR 304, radar sensor 306, camera 308, additional sensors 318, and vehicle position information 310 are input to central processor 302. The inputs are processed by algorithms in the form of code executed by central processor 302, to provide output signals that control the vehicle. Output signals from central processor 302 may be input, for example, into steering system 312, braking system 314, accelerator system 316, vehicle-to-vehicle communication system, and vehicle-to-station communication system. Stations may be equipped with receivers or transceivers to facilitate communications with or within vehicle control system 100. A user interface may be present at a station to provide a user with information from the electronic control unit in the form of manufacturing instructions specific to a vehicle. Intermediary processors may be incorporated between central processor 302 and the sensors 304, 306, 308, 318 or between central processor 302 and the vehicle systems 312, 314, 316, to process signals prior to signals being sent to devices that control motion of the vehicle. This additional processing can be in the form of filtering, for example, by implementing thresholds or other manipulation of signals may be conducted in preparation of outputting the signals to the actuators.

A partially assembled vehicle with a vehicle control system 100 can progress through an assembly line autonomously. In conventional vehicle manufacturing assembly processes, however, the vehicle would not be equipped to operate autonomously until near the end of the assembly process. For example, a drive train is typically installed as one of the last steps, which marries the engine chassis and body. Following this step on traditional assembly lines, brake lines, fuel pipes, air-line components, and essential connections for electric vehicles. Fuel, brake fluid and coolant are then filled into the vehicle and essential connections for electric vehicles are made. Finally, wheels are mounted and the steering wheel is installed. Some or all of these steps would be carried out during a first phase of manufacturing according to the described embodiments. Therefore, the traditional assembly line process would not generate a vehicle that could be self-powered and self-guided until the manufacturing process was nearly complete. Accordingly, any of the later process steps

After the step of installing the wheels noted above, the invention includes having the partially made vehicle self power and drive itself through the rest of the manufacturing process, including alignment and calibration. The self-guided and self-driven vehicle will arrive at each successive next station required for further fabrication of the vehicle.

It is only after the vehicle can be autonomously driven that additional assembly steps can be executed. Illustrative assembly line steps through which the vehicle may progress autonomously include: cockpit assembly, sunroof installation, door installation, interior and exterior mirror and light installation and seat placement and connection. The vehicle may also self-power to stations for systems calibration and vehicle testing.

Through the disclosed embodiments, the following equipment, personnel and “steps” may be eliminated, resulting in potential cost savings and process improvement: devices for conveying vehicle bodies, lifts, persons responsible for loading and unloading supplier parts to go from supplier warehouse to OEM factories, truck drivers and space (both at supplier warehouse and OEM factories) for storing parts.

Illustrative production facilities may be configured such that a vehicle can be taken out of line and the remaining vehicles can continue cycling through production. This can be accomplished manually or control system 100 can be configured to recognize events that warrant removal of a vehicle from the assembly line and also to autonomously guide the vehicle away from the line. The control system may be configured so vehicles removed from the assembly line may be guided to a single location or to a location specific to the event that triggered the vehicle's removal. This will prevent production line down time.

The specialized control device and components are configured so they will not interfere with the remainder of the manufacturing process. In an illustrative embodiment, control system 100 is configured to be hung on the front of the vehicle. Using its sensors, it can communicate with the vehicle on which it is hung and on other vehicles either directly or through components already installed in the vehicle, allowing all vehicles to be automated within the assembly process. Generally, control system 100 will be an external control module that can be removed once the vehicle is fully or partially assembled.

Embodiments of the autonomous assembly system may incorporate use of a traditional manifest that is placed on a vehicle and provides information on specific parts, features or other options that should be included with the specific vehicle. Typically, option codes are associated with options to be included on a vehicle. The option codes are used to determine what parts are needed for the vehicle. These codes can be stored in a database that is accessed pursuant to algorithms integrated with the autonomous conveyance and manufacturing system to automatically provide required parts to stations. Manifests can be coded and scanned or read by workers at stations and elsewhere in the manufacturing environment. Vehicles can be tracked throughout the manufacturing and delivery process, so a vehicle's position is always known to the system and can be identified by logistics or manufacturing personnel. Conventional digitized logistics systems for vehicle manufacturing can be integrated with control system 100 to further automate the manufacturing and delivery processes.

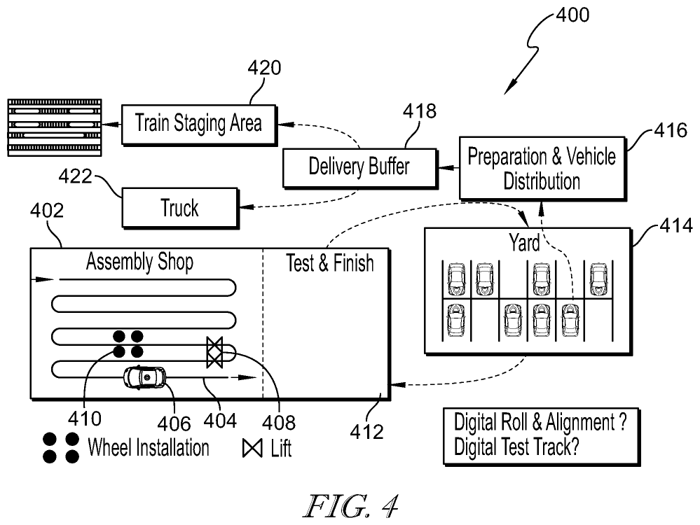

FIG. 4 is a schematic of an illustrative production layout 400. Area 402 is an assembly shop through which vehicles progress to various manufacturing stations along assembly line 404. Vehicle 406 advances through assembly line 404 and enters wheel installation station 410. Lift 408 elevates vehicle 406 to enable assembly line personnel or robotics to perform additional manufacturing steps. Vehicle 406 advances through additional portions of assembly line 404 and can then proceed further in an autonomous mode until all or most of the manufacture of the vehicle is complete, provided additional components have been installed to enable vehicle 406 to be self-driven. These additional components may be installed either prior to wheel installation or afterward. The earlier the vehicle can be rendered autonomous, the sooner it can proceed through the assembly line without the use of conveyors.

Vehicle 406 then progresses to a test and finish area 412. Vehicle 206 can be tested and evaluated for any manufacturing flaws or defects. Various finishing steps may be employed here. Vehicle 406 then advances to a yard 414, where it awaits return to the test and finish area 412 or advancement toward shipping and delivery. Depending on the nature of flaws or defects found, vehicle 406 may be returned to the test and finish area or to assembly line 404. Testing may include, for example, digital roll & alignment and digital test track.

Once vehicle 406 successfully completes testing and meets designated standards, it proceeds to preparation and vehicle distribution area 416. In vehicle preparation and distribution area 416, protective measures may be applied to vehicle 416 for transport purposes and other actions taken to facilitate safe and efficient transport and delivery of the vehicle.

Delivery buffering area 418 is the next stop for vehicle 406. Delivery buffering area 418 may serve to house vehicles awaiting shipment to dealers, for example. Buffering area 418 may also serve to maintain enough supply of vehicles to keep operations and delivery running on schedule. For example, delivery buffering area 418 may keep buffer inventory on hand to compensate for fluctuations in supply off of the manufacturing line.

Vehicle 406 leaves delivery buffer area 418 for either a train staging area 420 or a truck 422. Vehicle 405 may be loaded onto a train in area 424 where it will be delivered further down the distribution line. From wheel installation station 410 through delivery buffer area, and to trucks or train, vehicle 406 can be operated in autonomous mode all or some of the time.

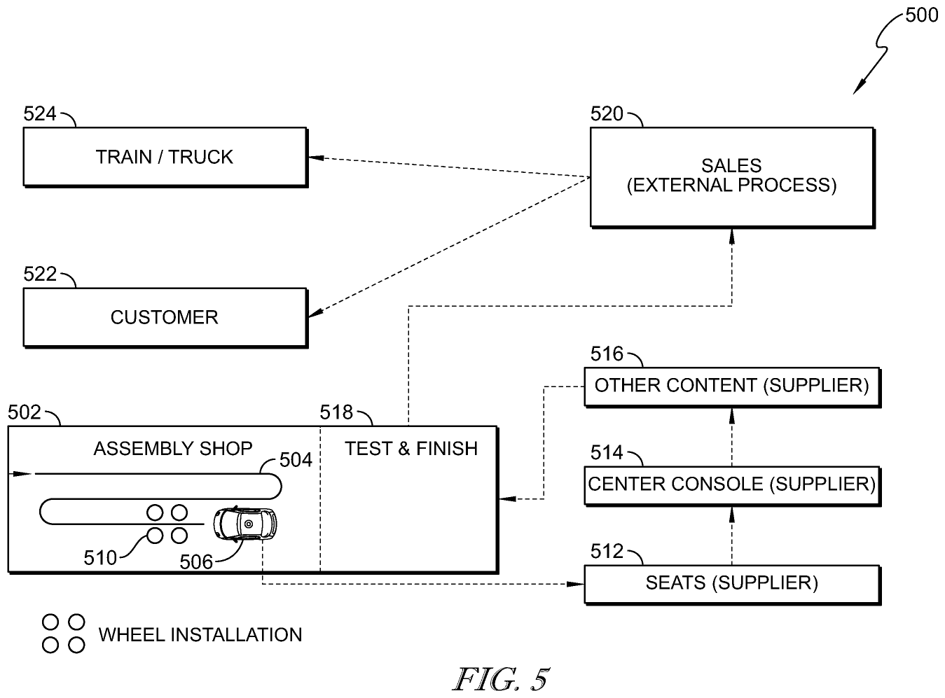

FIG. 5 is a schematic of a production layout according to a further illustrative embodiment. Assembly shop area 502 contains assembly line 504. Vehicle 506 enters assembly line 504 and immediately or soon thereafter undergoes wheel installation. FIG. 5 shows vehicle 506 progressing from a wheel installation station 510 in a self-driving mode, to further manufacturing stations. This indicates that vehicle 506 has all necessary components installed at that point to operate in an autonomous mode. Examples of additional manufacturing stations shown in FIG. 5 include seat installation 512, center console installation 514 and other content installation 516. Additional manufacturing stations 512, 514, 516 and others may be located at supplier sites rather than on the vehicle manufacturers' property. This may save time and costs of shipping parts to the manufacturing facility. Instead vehicle 506 can self-drive to the supplier location and have the installation of parts performed right there. As used herein, “supplier location” and similar terms refer to a location in which parts are warehoused, manufactured or are otherwise located. These sites may be supplier property or manufacturer property. Vehicle 506 can then proceed to testing and finish area 518, where further tasks can be performed, such as those described above with respect to production layout 400. From test and finish area 518, vehicle 506 can proceed to an external sales facility 520. This transition may also be accomplished in autonomous mode. From external sales facility 520 vehicle 506 may proceed, for example, to a customer location 522 or be loaded onto a truck or train in block 524. In production layout 500, vehicle 506 may proceed in autonomous mode in some or all of the steps after wheel installation station 510, provided other necessary components to facilitate self-driving are functionally installed in vehicle 506.

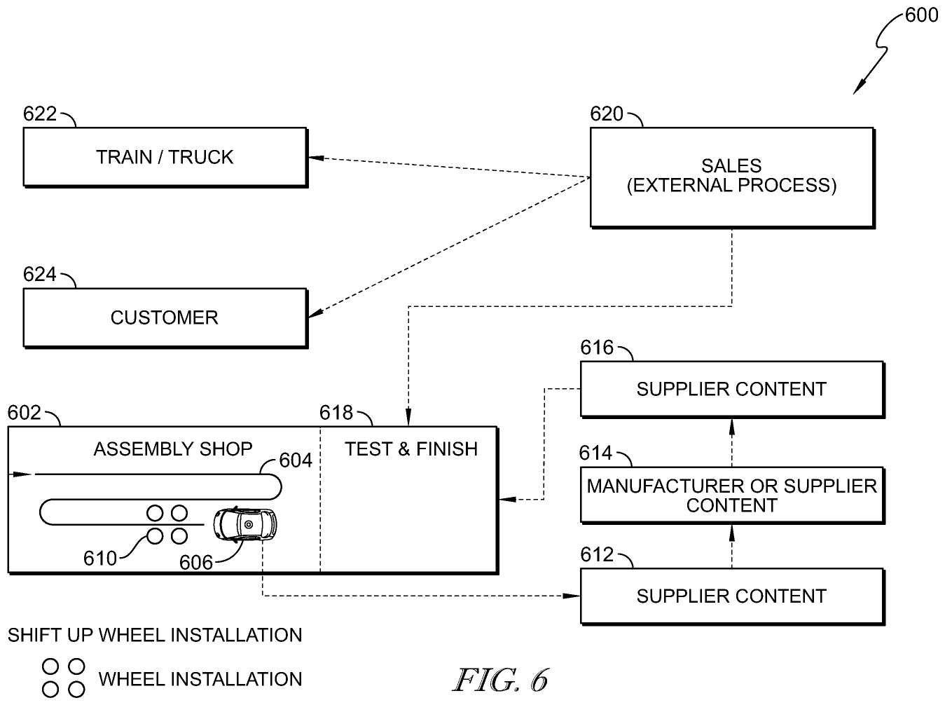

FIG. 6 is a schematic of an illustrative production layout 600 according to a further embodiment. In this embodiment wheel installation is shifted even further toward the beginning of the manufacturing process. The sooner wheel installation and autonomous vehicle control and actuating components can be installed, the earlier along the assembly line the vehicle can advance in a self-driving mode. Assembly shop area 602 includes assembly line 604 along, which vehicle 606 advances. Assembly line 604 is depicted shorter than assembly lines 404, 504 in FIG. 4 and FIG. 5, respectively, because the wheel installation station 610 occurs relatively early in the manufacturing process. Accordingly, supplier content added in blocks 612, 614, 616 may include additional manufacturing steps than are shown after wheel installation in production layouts 400, 500. In any of the supplier content steps, the components installed and sites where installation is performed may be those of the manufacturer or an outside supplier. But in each case, vehicle 606 may proceed through the content installation in an autonomous mode.

After supplier content is installed, vehicle 606 self-drives to a test and finish area 618, where testing and finishing as described above are performed. Once vehicle 606 is designated as having passed all tests and any finishing steps have been completed, vehicle 606 may move autonomously to an external sales location 620. From here, vehicle 606 can drive to a train or truck at location 622 or to a customer at location 624. It will be understood that although vehicle 606 is enabled as a self-driving vehicle during the manufacturing and before the testing and distribution processes, vehicle 606 may be driven by a human during any segment of the process as chosen or advanced for a manufacturing segment by other traditional means, such as conveyors. This is also the case with the illustrative production layouts of FIG. 4 and FIG. 5.

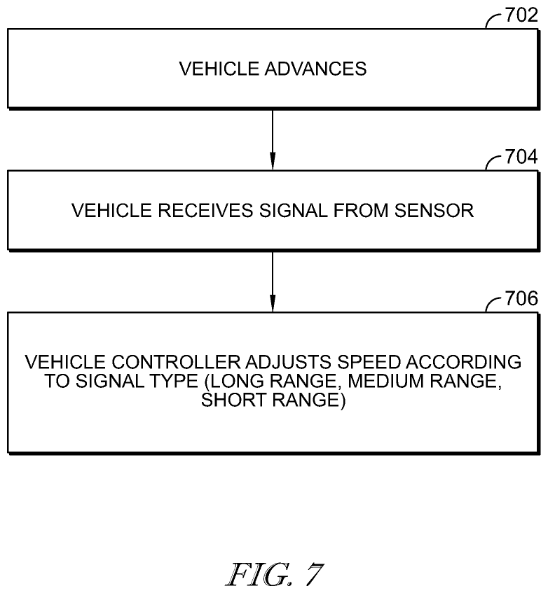

FIGS. 7, 8, 9 are flow charts describing illustrative processes of a vehicle progressing through a manufacturing plant. FIG. 7 is a flowchart outlining an object avoidance scheme according to an illustrative embodiment. In step 702, the vehicle advances along an assembly line, or to locations between coming off the assembly line and arriving at a customer or sales location. In step 704 the vehicle receives a signal from a sensor, such as radar sensor 104, visual management guide sensor 106, secondary pedestrian safety scanner 108, or other sensors associated with the vehicle or controller 110. In response to the signal or signals, vehicle controller 110, or other controller configured to adjust the speed of the vehicle, will slow or stop the vehicle to avoid the object that caused the signal to be generated in step 706. The signals may be generated from a device dedicated to detecting obstacles at long range, medium range or short range, or distances spanning any of those ranges. By way of example, a long range sensor may detect obstacles in the range of about 20 ft.-50 ft. with an illustrative target distance of 25 ft. The vehicle's braking assist system can be employed directly for the obstacle avoidance function or it can be controlled through controller 110.

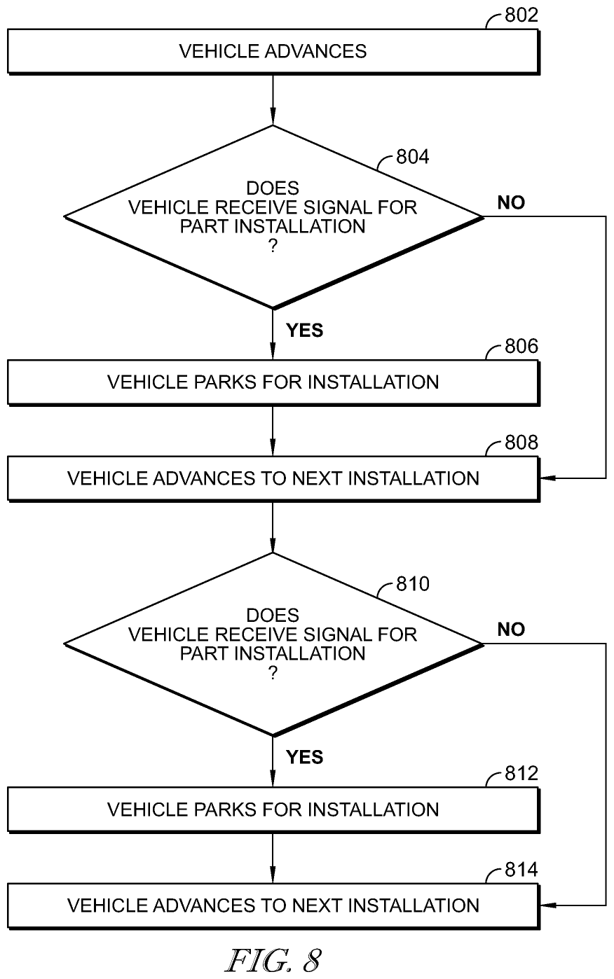

FIG. 8 is a flowchart showing a vehicle's path along an assembly line through multiple installation stations. In step 802, the vehicle advances along an assembly line. A signal, referred to for convenience as the “install signal,” will be generated either automatically or by user input as a vehicle approaches a station to designate whether the vehicle is to have a part installed or other work performed at an installation station. The term “station” is used broadly here to include any stops at which a vehicle along the assembly line may make in furtherance of the manufacturing process. In step 804, if the vehicle receives an install signal it will park as designated in step 806, so the installation task can be performed. If in step 804, the vehicle does not receive an install signal, the vehicle will drive through, bypass or otherwise not park at the installation station. In the case of not receiving an install signal or if the installation task is completed, the vehicle will advance along the assembly line in step 808. Again in step 810 it is determined whether the vehicle has received an install signal. If the vehicle has, in step 812 it parks so the installation task can be performed. If the vehicle has not received an install signal it will advance toward the next install station in step 814. Similarly, after a vehicle that has received an install signal in step 810, and the installation has been completed, the vehicle will advance along the assembly line in step 814.

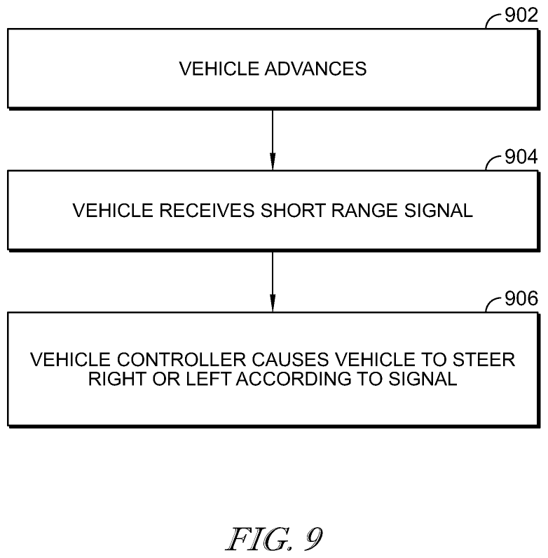

FIG. 9 is a flowchart showing a vehicle steering autonomously through a manufacturing plant, such as advancement through the assembly line, or through locations along the way to reaching a customer or showroom. In step 902 the vehicle advances forward, such as along a y-axis. If the vehicle veers from the y-axis or deviates from a predetermined path, the vehicle will receive a signal, for example from a short range sensor, in step 904. The sensor may be the visual management guide sensor 106. The received signal will cause the vehicle to either steer right or steer left to avoid a detected obstacle, correct direction to remain along a predefined course or otherwise move in an assigned direction.

Electronic tracking systems for vehicle advancing through manufacturing, testing and delivery processes may be employed to coordinate the autonomous vehicle features with the manufacturing process. Vehicle positions and parts information can be monitored and relayed and/or displayed to users in real time. Data exchange, for example using Bluetooth technology, can also be employed. Conventional body tracking can also be coordinated with the autonomous vehicle manufacturing controllers. Parts inventory, location and distribution to stations where needed can be coordinated with the control system.

Various embodiments have been described, each having a different combination of elements. The invention is not limited to the specific embodiments disclosed, and may include different combinations of the elements disclosed, omission of some elements or the replacement of elements by the equivalents of such structures and devices.

While illustrative embodiments have been described, additional advantages and modifications will occur to those skilled in the art. Therefore, the invention in its broader aspects is not limited to specific details shown and described herein. Modifications, for example, self-driving features, sequence of steps and incorporation of equivalent components, may be made without departing from the spirit and scope of the invention. Accordingly, it is intended that the invention not be limited to the specific illustrative embodiments, but be interpreted within the full spirit and scope of the appended claims and their equivalents.

1. A vehicle manufacturing method comprising:
assembling together a chassis, accelerator system, steering system, braking system, computer, and wheels to create a partially fabricating a vehicle;
providing a control system in communication with the computer of the partially fabricated vehicle wherein the control system comprises:
one or more sensors; and
a gateway configured to interface inputs from the one or more sensors with the vehicle;
sensing surroundings of the vehicle by the control system and accessing by the control system the steering system of the vehicle to steer the vehicle based on the sensed surroundings; and
communicating by the control system information pertaining to further vehicle assembly steps for use in manufacturing substation.

2. The method of claim 1 further comprising:
completing fabrication steps to create a completed vehicle; and
self-guiding the completed vehicle through one or more delivery steps.

3. The method of claim 1 further comprising:
identifying flawed vehicle builds;
taking the flawed vehicle builds out of the assembly line; and
permitting other vehicles in the assembly line to continue along the assembly line to one or more of the plurality of additional assembly line fabrication steps without assembly line stoppages.

4. The method of claim 1 wherein at least one of the one or more sensors is a visual management guide sensor configured to follow a pre-determined path along the assembly line.

5. The method of claim 1 wherein the control system is integrated with a vehicle tracking system.

6. The method of claim 1 wherein at least one of the one or more sensors is a pedestrian safety scanner.

7. The method of claim 1 further comprising self-driving the vehicle to a parts warehouse for part installation.

8. A vehicle manufacturing control system for use in a vehicle manufacturing process comprising:
one or more sensors;
a gateway configured as an interface between the one or more sensors and the vehicle to receive data from the one or more sensors and output commands based on the received data to the vehicle to operate the vehicle;
an electronic control unit wherein;
the electronic control unit is configured to autonomously execute one or more vehicle functions;
the electronic control unit is configured to sense surroundings of the vehicle;
the electronic control unit is integrated with a vehicle tracking system; and
the electronic control unit is configured to communicate with manufacturing substations.

9. The control system of claim 8 wherein the one or more sensors comprises a visual management guide sensor.

10. The control system of claim 9 wherein the visual management guide sensor is configured to:
provide visual or magnetic strip guidance to follow a pre-determined path; and
output data to the gateway to ensure the vehicle is moving on a correct path within an allowed space.

11. The control system of claim 8 wherein the one or more sensors comprises a pedestrian safety scanner.

12. The control system of claim 8 wherein the one or more vehicle functions are selected from steering, acceleration/deceleration, environment monitoring, and dynamic driving task fallback strategies.

13. The control system of claim 8 wherein the vehicle tracking systems is configured to track location and identification of vehicles on the assembly line and parts needed by the vehicle for vehicle fabrication completion.
